(19) United States
(12) Patent Application Publication
(10) Pub. No.: US 2015/0113470 A1
(43) Pub. Date: Apr. 23, 2015

(54) ADJUSTABLE PROGRESSIVE DISCLOSURE OF STRUCTURED DATA

(71) Applicant: Cisco Technology, Inc., San Jose, CA (US)

(72) Inventor: Daniel Miller, Sunnyvale, CA (US)

(73) Assignee: Cisco Technology, Inc., San Jose, CA (US)

(21) Appl. No.: 14/058,197

(22) Filed: Oct. 18, 2013

(51) Int. Cl. G06F 3/0484; G06F 3/0485; G06F 3/0481

(52) U.S. Cl. CPC G06F 3/04847; G06F 3/04817; G06F 3/04842; G06F 3/0485
USPC 715/777; 715/786

(57) ABSTRACT

Representations of structured data ordered by level of abstraction are defined. A defined representation of the structured data at one of the levels of abstraction is displayed in a graphical user interface (GUI) of a computing device. A progressive disclosure object, comprising a one-dimensional range, having ordered positions along the range corresponding to each level of abstraction of the defined representations, and a position indicator at a first position on the range associated with the level of abstraction of the displayed representation is displayed in the GUI. The position indicator is movable along the range via the GUI. Input is received via the GUI changing the position of the position indicator to a second position different than the first position. The defined representation of the structured data at the level of abstraction corresponding to the second position is displayed in the GUI.

### TECHNICAL FIELD

The disclosed technology generally relates to data visualization, and more particularly to computer user interface approaches for visualizing structured data.

### BACKGROUND

“Structured data,” as commonly used, refers to information organized in accordance with a model. For example, the data of a computer database can be modeled using a hierarchical model, a network model, a relational model, or an object-relational model, among other types of models. Perhaps the most common approach to managing large sets of data on a computer is the relational database management system (RDBMS), which, as its name indicates, uses a relational model that is typically based on first order predicate logic.

The use of structured data sets, such as in an RDBMS, can provide a powerful tool for organizing a large corpus of data, making the corpus amenable to query, and displaying portions of the data set responsive to queries. However, even with the use of sophisticated structured data models, creating a user-friendly interface for querying a store of structured data and for displaying the results of such a query to a user can be a challenge, especially for a large data corpus. For example, in-line expansion, as typically used for user interaction with files in the hierarchical file directory structure implemented in most computers, can be a cumbersome way for a human user to visualize the nominal characteristics, temporal characteristics, and other characteristics of the files accessible via the computer.

### BRIEF DESCRIPTION OF THE DRAWINGS

FIG. 1 is a block diagram of an architecture for example embodiments of the technology disclosed herein.

FIG. 2 is a block flow diagram depicting methods for adjustable progressive disclosure of structured data, in accordance with certain example embodiments.

FIG. 3 illustrates a graphical user interface (GUI) for adjustable progressive disclosure of structured data, in accordance with certain example embodiments.

FIG. 4 illustrates a graphical user interface (GUI) for adjustable progressive disclosure of structured data, in accordance with certain example embodiments.

FIG. 5 illustrates a graphical user interface (GUI) for adjustable progressive disclosure of structured data, in accordance with certain example embodiments.

FIG. 6 illustrates a graphical user interface (GUI) for adjustable progressive disclosure of structured data, in accordance with certain example embodiments.

FIG. 7 illustrates a graphical user interface (GUI) for adjustable progressive disclosure of structured data, in accordance with certain example embodiments.

FIG. 8 illustrates a graphical user interface (GUI) for adjustable progressive disclosure of structured data, in accordance with certain example embodiments.

FIG. 9 illustrates a graphical user interface (GUI) for adjustable progressive disclosure of structured data, in accordance with certain example embodiments.

FIG. 10 illustrates a block diagram depicting a computing machine and a module, in accordance with certain example embodiments.

These and other aspects, objects, features, and advantages of the example embodiments will become apparent to those having ordinary skill in the art upon consideration of the following detailed description of illustrated example embodiments.

### DESCRIPTION OF EXAMPLE EMBODIMENTS

### Overview

Embodiments of the present technology include computer-implemented methods, apparatuses, and computer program products for adjustable progressive disclosure of structured data. In some embodiments of the technology, representations of a structured data set are defined in one or more computing devices. The representations can be ordered by level of abstraction. A defined representation of the structured data set at one of the levels of abstraction can be caused to be displayed in a graphical user interface (GUI) of a computing device.

A progressive disclosure object, such as a slider, comprising a one-dimensional range and a position indicator can be caused to be displayed in the GUI. The one-dimensional range can include ordered positions along the range corresponding to each level of abstraction of the defined representations. The position indicator can be located at a first position along the range associated with the level of abstraction of the displayed representation. The position indicator can be movable along the range via the GUI.

Input changing the position of the position indicator to a second position different than the first position can be received. The defined representation of the structured data set at the level of abstraction corresponding to the second position can be caused to be displayed in the GUI.

### DESCRIPTION

Turning now to the drawings, in which like numerals represent like (but not necessarily identical) elements throughout the figures, example embodiments of the present technology are described in detail.

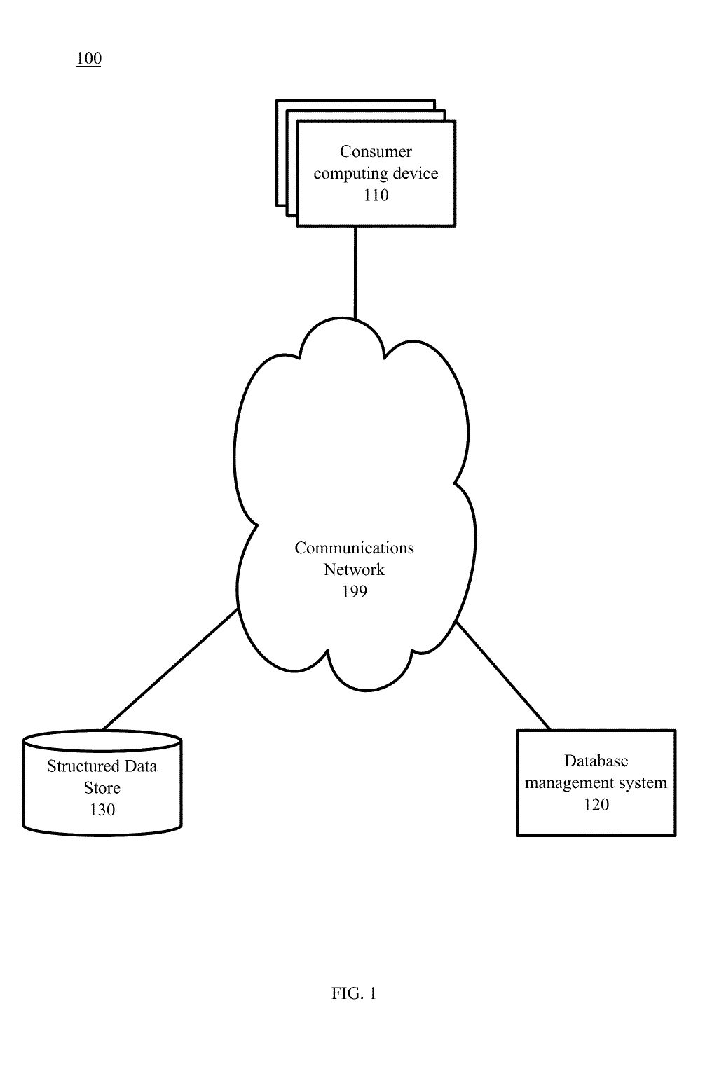

FIG. 1 is a diagram of an architecture 100 for example embodiments of the technology disclosed herein. As depicted in FIG. 1, the architecture 100 includes network computing devices 110, 120, and 130, each of which may be configured to communicate with one another via communications network 199. In some embodiments, a user associated with a device must install an application and/or make a feature selection to obtain the benefits of the techniques described herein.

Network 199 includes one or more wired or wireless telecommunications means by which network devices may exchange data. For example, the network 199 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a Bluetooth® connection, a near field communication (NFC) connection, any combination thereof, and any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network device can include a communication module capable of transmitting and receiving data over the network 199. For example, each network device can include a server, a desktop computer, a laptop computer, a tablet computer, a television with one or more processors embedded therein and/or coupled thereto, a smart phone, a handheld computer, a personal digital assistant (PDA), or any other wired or wireless processor-driven device. In the example embodiment depicted in FIG. 1, the network device 110 may be operated by a user, and network devices 120 and 130 may be operated by a database management system (DBMS) operator, respectively.

The network connections illustrated are example and other means of establishing a communications link between the computers and devices can be used. Additionally, those having ordinary skill in the art having the benefit of the present disclosure will appreciate that the network devices illustrated in FIG. 1 may have any of several other suitable computer system configurations. For example, a user device 110 embodied as a mobile phone or handheld computer may not include all the components described above.

The example methods illustrated in the following figures are described hereinafter with respect to the components of the example architecture 100. The example methods may also be performed with other systems and in architectures.

In such an architecture 100, a DBMS 120 can define representations of structured data stored in data store 130. The defined representations can be ordered by level of abstraction of each representation. A user may query the data store 130 via the DBMS 120 using the consumer computing device 110. The DBMS 120 can retrieve data from the structured data store 130 that corresponds to the query, and cause the results to be displayed in a GUI of the consumer computing device 110 using one of the defined representations of the structured data. The consumer computing device 110 can display a progressive disclosure object comprising a one-dimensional range and a position indicator in the GUI of the consumer computing device 110. The range can include positions along the range corresponding to each level of abstraction of the defined representations. The position indicator can be displayed at a position along the range associated with the level of abstraction of the displayed representation. The position indicator can be movable along the range by a user via the GUI of the consumer computing device 110. The consumer computing device 110 can receive input changing the position of the position indicator to a second position different than the first position. Then, the defined representation of the structured data set at the level of abstraction corresponding to the second position can be displayed in the GUI of the consumer computing device 110.

While certain portions of the present technology have been described above as being performed or caused by certain components of the example architecture, one of skill in the art of the technology will recognize that the technology can be implemented by allocating portions in other fashions. For example, representations of the structured data at different levels of abstraction can be defined in the consumer computing device 110.

Consider, as an ongoing example, a data store that describes characteristics of members of a product development team. A “persona” for each team member is stored in the data store. Each persona identifies the team member by name and role, and includes information relating that team member to various phases of the product development cycle. TABLE 1 represents a hierarchical tabular organization of information types in each persona.

TABLE 1

PERSONA

Name
Role
Category
Responsibilities

Prospect Responsibilities
Qualification Responsibilities
Proposal Responsibilities
Agreement Responsibilities
Close Responsibilities

Information Requirements

Prospect Information Requirements
Qualification Information Requirements
Proposal Information Requirements
Agreement Information Requirements
Close Information Requirements

Pain Points

Prospect Pain Points
Qualification Pain Points
Proposal Pain Points
Agreement Pain Points
Close Pain Points

Tools

Prospect Tools
Qualification Tools
Proposal Tools
Agreement Tools
Close Tools

Phase Involvement
Customer Size

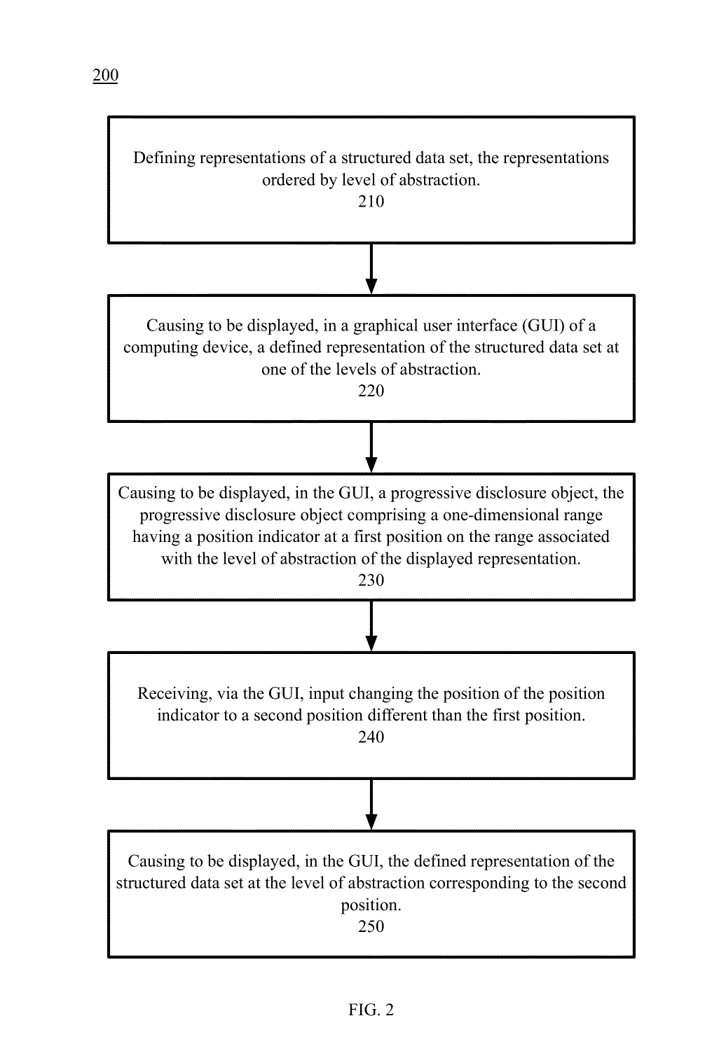

Referring to FIG. 2, and continuing to refer to FIG. 1 for context, methods 200 for adjustable progressive disclosure of structured data in accordance with embodiments of the present technology are illustrated. In such methods, representations of a structured data set are defined—Block 210. A representation of the structured data set can be characterized by a set of data items at one or more levels of the data structure. Those representations can be ordered by the level of abstraction of each representation. In the continuing example, six (6) levels of abstraction of the structured data are defined, increasing in detail and decreasing in abstraction from level 1 to level 6.

TABLE 2 defines the levels, wherein “X” indicates elements of the persona structured data that are included in the representation. Under certain circumstances, the degree of detail or abstraction present in each representation can be determined by user research to prioritize data fields, for example, according to common use cases. As applied to the ongoing example, levels 1-6 represent six use cases of increasing level of detail, in other words, decreasing level of abstraction. A filter, indicated in TABLE 2 by “F,” for category is also included in each representation. In some embodiments, at least one representation of the structured data set comprises a summary of at least one level of the hierarchy of the hierarchical tabular data set.

TABLE 2

| PERSONA | | 1 | 2 | 3 | 4 | 5 | 6 |
|---|---|---|---|---|---|---|---|
| Photo | | X | X | X | X | X | X |
| Name | | X | X | X | X | X | X |
| Role | | X | X | X | X | X | X |
| Category | | F | F | F | F | F | F |
| Responsibilities | | X | X | X | X | X | X |
| | Prospect Resp. | | | X | X | X | X |
| | Qualification Resp. | | | X | X | X | X |
| | Proposal Resp. | | | X | X | X | X |
| | Agreement Resp. | | | X | X | X | X |
| | Close Resp. | | | X | X | X | X |
| Information Requirements | | | | X | X | X | X |
| | Prospect Info. Rqmts | X | X | X | X | X | X |
| | Qualification Info. Rqmts | | | | X | X | X |
| | Proposal Info. Rqmts | | | | X | X | X |
| | Agreement Info. Rqmts | | | | X | X | X |
| | Close Info. Rqmts | | | | X | X | X |
| Pain Points | | | | | X | X | X |
| | Prospect Pain Points | X | X | X | X | X | X |
| | Qualification Pain Points | | | | | X | X |
| | Proposal Pain Points | | | | | X | X |
| | Agreement Pain Points | | | | | X | X |
| | Close Pain Points | | | | | X | X |
| Tools | | | | | | X | X |
| | Prospect tools | | X | X | X | X | X |
| | Qualification Tools | | | | | | X |
| | Proposal Tools | | | | | | X |
| | Agreement Tools | | | | | | X |
| | Close Tools | | | | | | X |

| | | | | | |
|---|---|---|---|---|---|
| Phase Involvement | X | X | X | X | X |
| Customer Size | X | X | X | X | X |

Embodiments of the technology can cause a defined representation of the structured data set at one of the levels of abstraction to be displayed in a graphical user interface (GUI) of a computing device—Block 220. For example, the DBMS 120 can receive a query from a thin client of the technology operating on the consumer computing device 110, retrieve data responsive to the query from the structured data store 130, and send those data items called for by a representation of the current level of abstraction to the thin client. The thin client then displays the responsive data at the current level of abstraction on the consumer computing device 110.

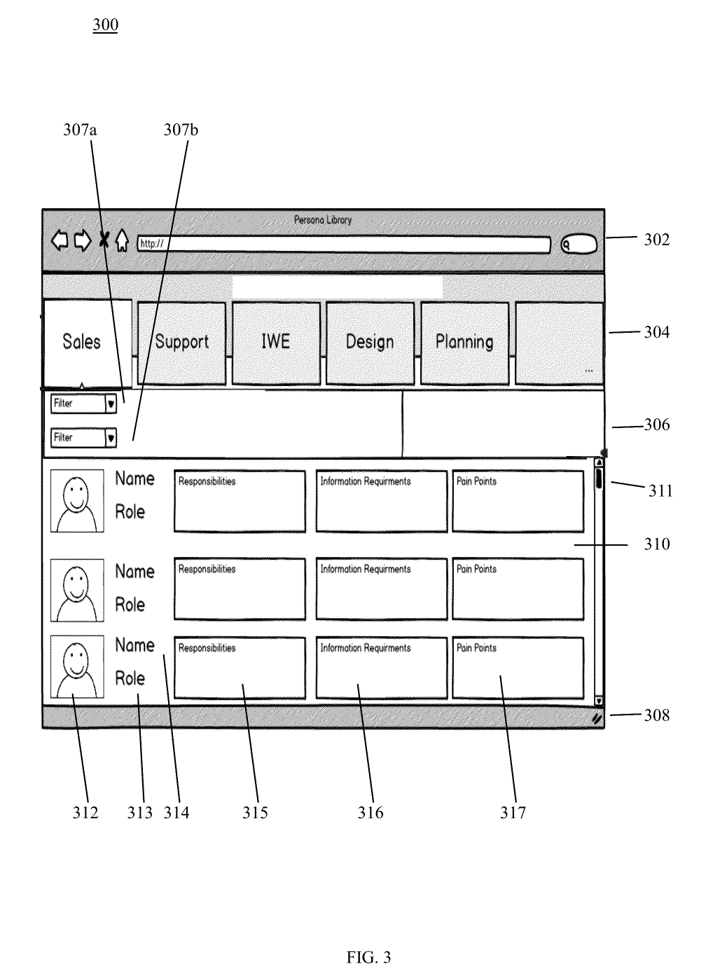

Referring to FIG. 3 and continuing to refer to prior figures for context, a graphical user interface (GUI) 300 for adjustable progressive disclosure of structured data in accordance with the continuing example is presented. In the example, the GUI 300 is divided into five (5) portions: window control 302, category portion 304, results control portion 306, status portion 308, and results portion 310. In the continuing example, the category and filters correspond to the “query,” to the structured data store, while the response to the query is given by the representations of personas displayed in results portion 310.

Category portion 304 can act as a filter across persona categories. Other filters can be added using pull-down menus 307a and 307b in portion 306. In some embodiments, such filters can include range fields or free-form Boolean fields. Portion 310 is formatted to contain the representation defined for the first level of abstraction of TABLE 2. The first level of abstraction displayed in portion 310 includes entries for multiple personas. Though only three (3) are shown, others fitting the category and any applied filters can be accessed using the scroll control 311 for portion 310.

In accordance with the representation defined for the first level of abstraction in TABLE 2, for each persona displayed in portion 310, the following fields are included: photo 312, role 313, name 314, “Responsibilities” header 315, “Information Requirements” header 316, and “Pain Points” header 317. In some embodiments, the various headers can contain a summary of the underlying contents. For example, an encoded representation of the contents, such as abbreviations for various tools available (“WP, SS, PDF, . . . ” for word processing software, spreadsheet software, and a PDF reader, respectively, in the continuing example) can be displayed as header information.

Returning to FIG. 2, embodiments of the technology can cause the display of a progressive disclosure object in the GUI—Block 230. The progressive disclosure object includes a one-dimensional range and a position indicator. The one-dimensional range is characterized by ordered positions along the range corresponding to each level of abstraction of the defined representations. The position indicator is located at a position on the range associated with the level of abstraction of the displayed representation. The position indicator is movable along the range by a user via the GUI. For example, the thin client of the technology operating on the consumer computing device 110, having received information from the DBMS of the level of abstraction of the displayed data representation, can displays the position indicator at a position on the range of the progressive disclosure object at a position corresponding to the displayed level of abstraction.

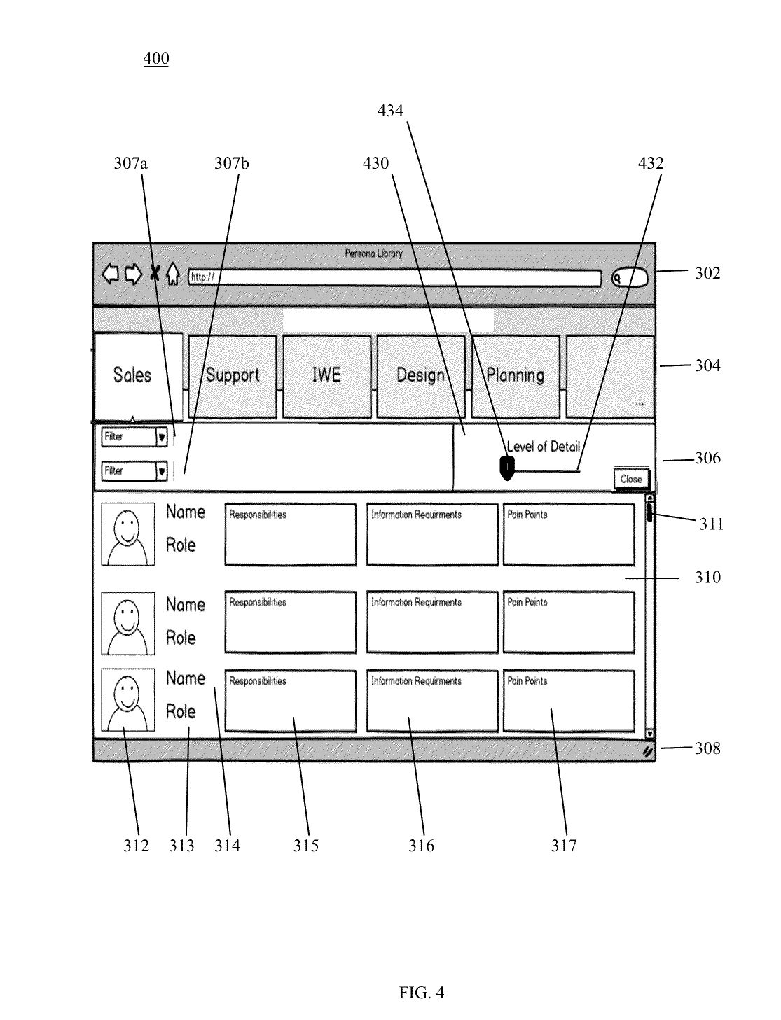

Referring to FIG. 4 and continuing to refer to prior figures for context, a graphical user interface (GUI) 400 for adjustable progressive disclosure of structured data in accordance with the continuing example is presented. In the example, the GUI 400, elements 302 through 317 remain as described elsewhere herein. FIG. 4 illustrates progressive disclosure object 430 having the caption “Level of Detail.” Progressive disclosure object range 434 and position indicator 432 are shown therein. Position indicator 432 is shown at the leftmost position on the range 434. In the continuing example, this position corresponds to the representation of the structured data set at the first level of abstraction. In some embodiments of the technology, the progressive disclosure object can have a one-dimensional range in a shape other than a straight line (for example, in the shape of an arc), and in an orientation other than horizontal include (for example, vertical or diagonal).

In some embodiments, the one-dimensional progressive disclosure object is in the shape of a circular dial. In such embodiments, relative position can be measured from a given position (for example, vertical orientation of an indicator on the dial being 0 degrees), such that one complete revolution indicates a different position in the range of the progressive disclosure object.

Returning to FIG. 2, embodiments of the technology can receive, via the GUI, input changing the position of the position indicator to a second position different than the first position—Block 240. For example, the thin client of the technology operating the on the consumer computing device 110 can receive input moving the position indicator to a new position to the right of the indicator's current position 432. The technology can cause the defined representation of the structured data set at the level of abstraction corresponding to the second position to be displayed in the GUI—Block 250. For example, the thin client operating on the consumer computing device 110 can transmit the new position to the DMBS 120. The DBMS 120 can retrieve data responsive to the present query from the structured data store 130, and send those data items called for by the representation of the level of abstraction corresponding to the new position of the position indicator to the thin client. The thin client then displays the responsive data at the new level of abstraction on the consumer computing device 110.

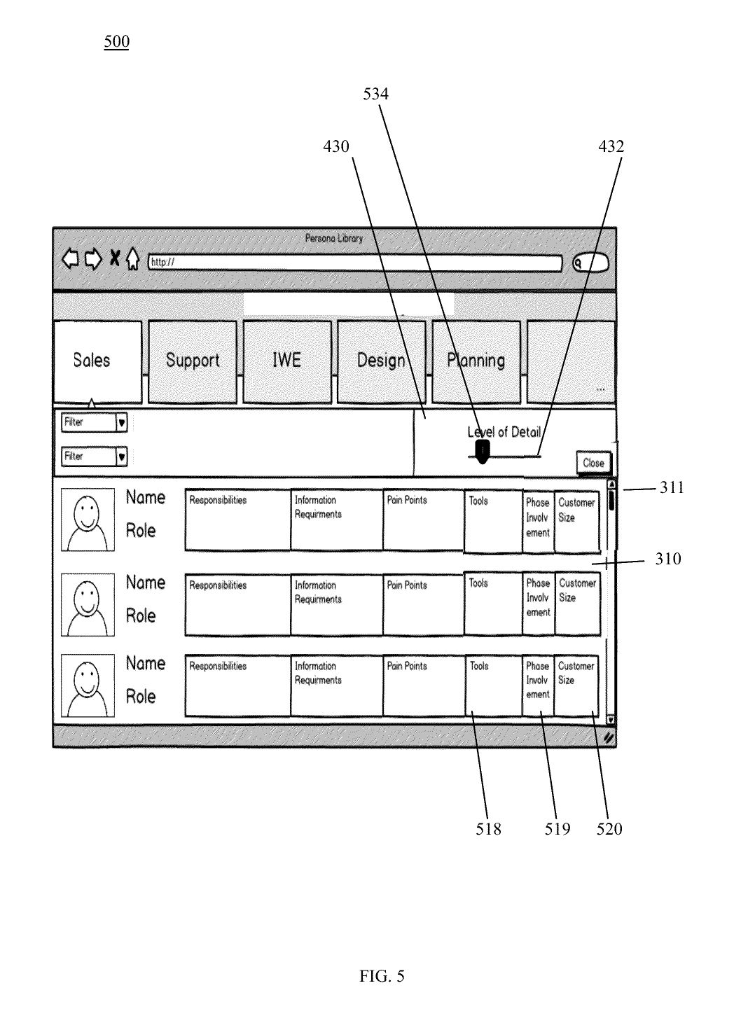

Referring to FIG. 5, and continuing to refer to prior figures for context, a graphical user interface (GUI) 500 for adjustable progressive disclosure of structured data in accordance with the continuing example is presented. In the example GUI 500, elements 302 through 317 remain as described elsewhere herein. FIG. 5 illustrates position indicator 534 moved to the right relative to the position of position indicator 434 of FIG. 4. As a consequence, the second level of abstraction illustrated in TABLE 2 is displayed in portion 310 of the GUI. In addition to displaying a photo 312, role 313, name 314, responsibilities 315, information requirements 316, and pain points 317 for each persona responsive to the category selected and any filters applied, portion 310 displays tools 518, phase involvement 519, and customer size 520 for each persona.

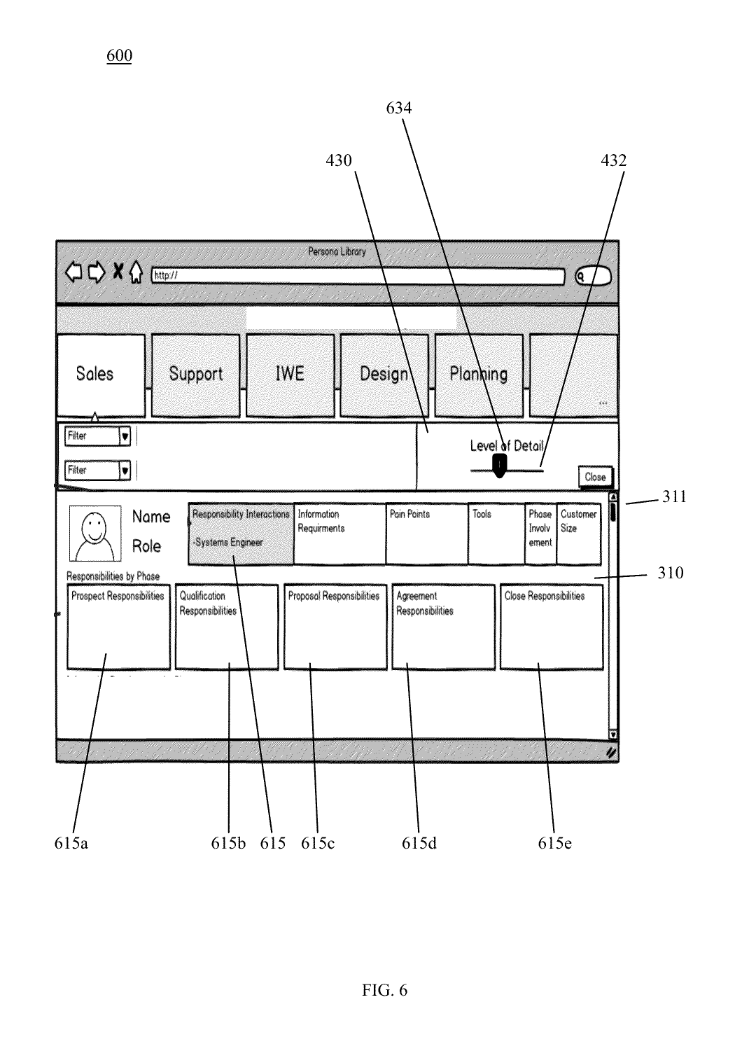

Referring to FIG. 6, and continuing to refer to prior figures for context, a graphical user interface (GUI) 600 for adjustable progressive disclosure of structured data in accordance with the continuing example is presented. In the example, the GUI 600, elements referred to as 302-317, 430, 432, and 518-520 are described elsewhere herein. FIG. 6 illustrates position indicator 634 moved to the right relative to the position of position indicator 534 of FIG. 5. As a consequence, the third level of abstraction illustrated in TABLE 2 is displayed in portion 310 of the GUI. In addition to displaying a photo 312, role 313, name 314, information requirements 316, pain points 317, tools 518, phase involvement 519, and customer size 520 for each persona responsive to the category selected and any filters applied, portion 310 displays an alternate responsibilities box 615, along with detailed responsibilities by phase for project responsibilities 615a, qualification responsibilities 615b, proposal responsibilities 615c, agreement responsibilities 615d, and close responsibilities 615e for each persona displayed. In FIG. 6, only one persona is displayed; others can be displayed by scrolling using scroll bar 311.

As an additional example, consider that structured data sets provide an excellent framework for disseminating interrelated information on a range of subjects, however the large corpus defining a set can easily overwhelm users. Additionally, methods of filtering the data into a desired subset can be complicated, or difficult to manipulate quickly. It can be useful to have a mechanism for quickly manipulating a structured data set into desired subsets, in an intuitive manner.

In context of information browsing or retrieval regarding large data sets, it can be useful to visualize varying degrees of detail. In some embodiments, the technology disclosed herein can be operated by the user to reveal or conceal data fields within each record, in an intuitive fashion—a form of progressive disclosure. The mechanism for adjustable progressive disclosure of data fields can be represented, in some embodiments, by a slide bar such that the setting on the leftmost section of the bar displays a minimum of information, while the rightmost setting displays the maximum amount of information for each record, with gradients in between. One-dimensional adjustable progressive disclosure representations other than a slide bar are described elsewhere herein. In some embodiments, two-dimensional objects, such as an array, can be used to represent adjustable progressive disclosure. For example, the vertical axis of such an array can represent the number of levels of the data structure hierarchy that are represented, and the horizontal axis can represent the degree of detail for one or more elements of the displayed level. As a more specific example, the lower left area of such an array can correspond to field names for those fields at the first level of the hierarchy of the structured data, the upper left can correspond to the most level of detail about each of the fields at the first level of the hierarchy. The lower right of the array can correspond to the field names for those fields at all levels of the hierarchy, while the upper right of the array can correspond to the most level of detail for all field at all levels of the hierarchy. The gradation of hierarchy and detail in between these extremes can be linear, or non-linear, including different gradations for each axis.

Embodiments of the present technology are different from other implementations of progressive disclosure such as dropdown menus, or inline expansion in various ways, including handling a greater number of data fields through a simple mechanism. Using inline expansion, for increased detail, the user has to click on each line element the user is interested in. With embodiments of the present technology, the user may increase and decrease the level of detail rapidly over a number of data fields. In some embodiments of this technology user research can be used to prioritize the data fields according to common use cases.

Embodiments of the present technology can be quicker than the use of filters, which typically require the user to manually select the desired options. This can lead to complex systems that can either take a long time to select the desired configuration, or one where a number of filters are never selected. Embodiments of the present technology find use particularly in scenarios where the use cases are well documented, or the user is a novice to the data set, and is unsure of which data fields will be most useful.

Inline expansion is less flexible than embodiments of the present technology, since with inline expansion the user has to manually select the lines to view more details. If the user wants to view a particular data field across all elements, it can be tedious to click to the desired field for all elements. In embodiments of the present technology, the user can adjust the progressive disclosure mechanism to include the desired data field, and simply scroll through all the elements.

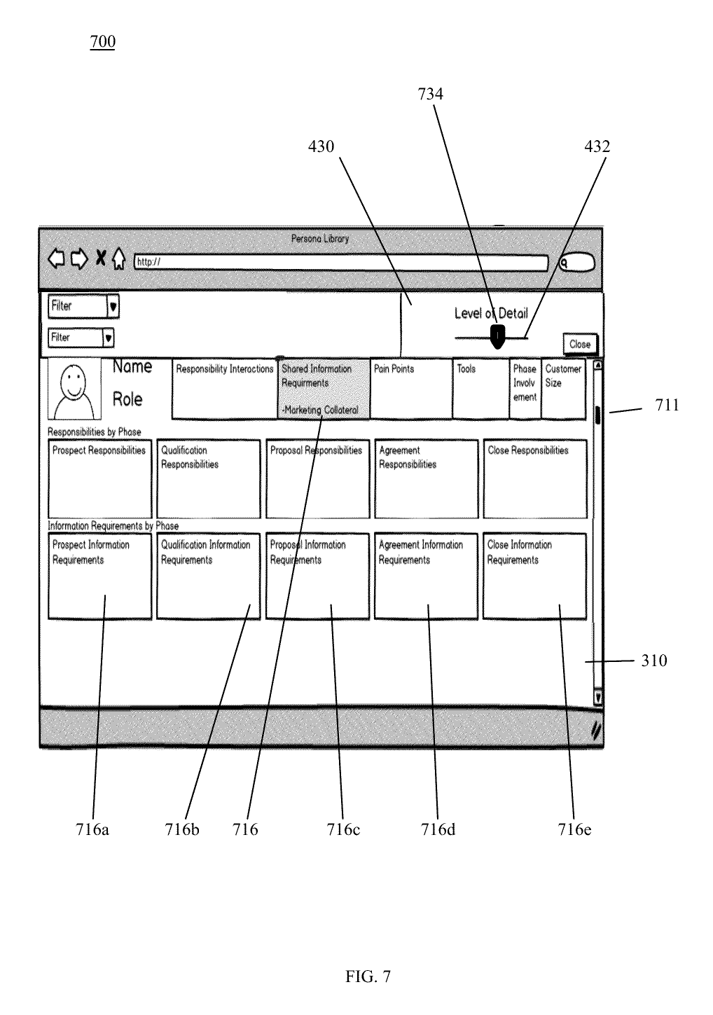

Referring to FIG. 7, and continuing to refer to prior figures for context, a graphical user interface (GUI) 700 for adjustable progressive disclosure of structured data in accordance with the continuing example is presented. In the example, the GUI 700, elements referred to as 302-317, 430, 432, 518-520, 615, and 615a-615e are described elsewhere herein. FIG. 7 illustrates position indicator 734 moved to the right relative to the position of position indicator 634 of FIG. 6. As a consequence, the fourth level of abstraction illustrated in TABLE 2 is displayed in portion 310 of the GUI. In addition to displaying a photo 312, role 313, name 314, responsibility interactions 615, pain points 317, tools 518, phase involvement 519, and customer size 520 for each persona responsive to the category selected and any filters applied, portion 310 displays an alternate shared information requirements box 716, along with detailed information requirements by phase for project information requirements 716a, qualification information requirements 716b, proposal information requirements 716c, agreement information requirements 716d, and close information requirements 716e for each persona displayed. Note that scroll bar 711 is moved lower in comparison to scroll bar 311, and as a consequence, category portion 304 has moved up and out of the window. Also note that detailed responsibilities by phase remain displayed in portion 310 as described with respect to FIG. 6.

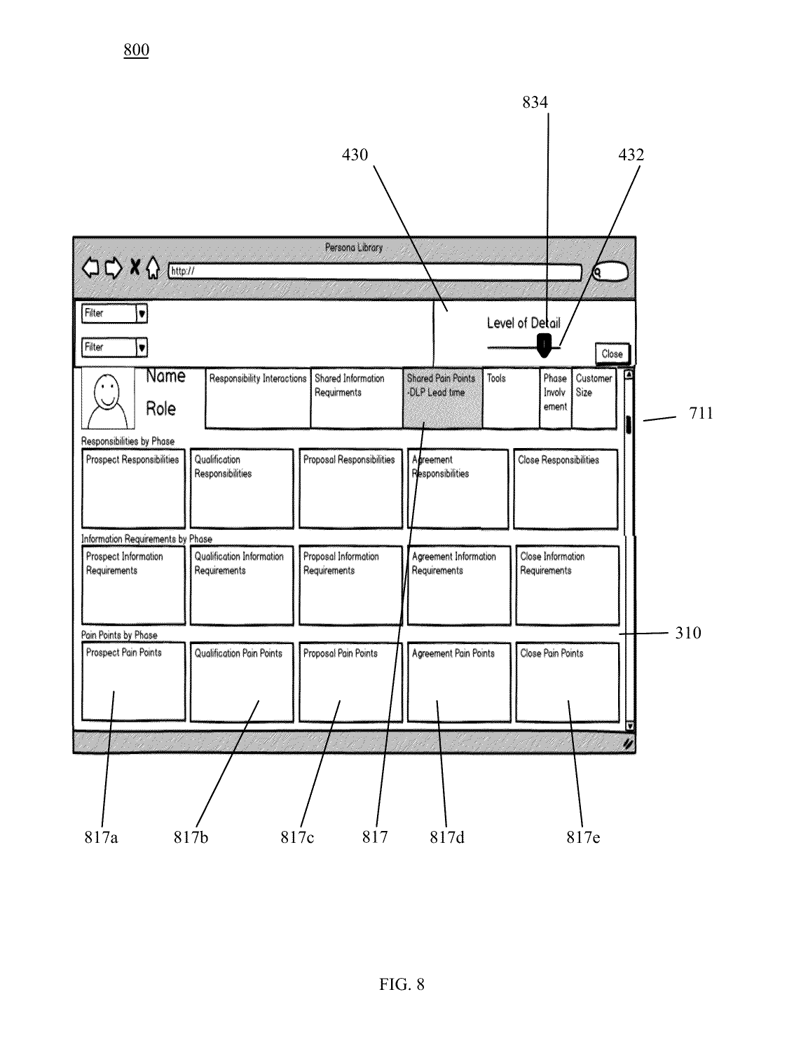

Referring to FIG. 8, and continuing to refer to prior figures for context, a graphical user interface (GUI) 800 for adjustable progressive disclosure of structured data in accordance with the continuing example is presented. In the example, the GUI 800, elements referred to as 302-315, 317, 430, 432, 518-520, 615, 615a-615e, 711, 716, and 716a-716e are described elsewhere herein. FIG. 8 illustrates position indicator 834 moved to the right relative to the position of position indicator 734 of FIG. 7. As a consequence, the fifth level of abstraction illustrated in TABLE 2 is displayed in portion 310 of the GUI. In addition to displaying a photo 312, role 313, name 314, responsibility interactions 615, shared information requirements 716, tools 818, phase involvement 519, and customer size 520 for each persona responsive to the category selected and any filters applied, portion 310 displays an alternate shared pain points box 817, along with pain points by phase boxes project pain points 817a, qualification pain points 817b, proposal pain points 817c, agreement pain points 817d, and close pain points 817e in portion 310.

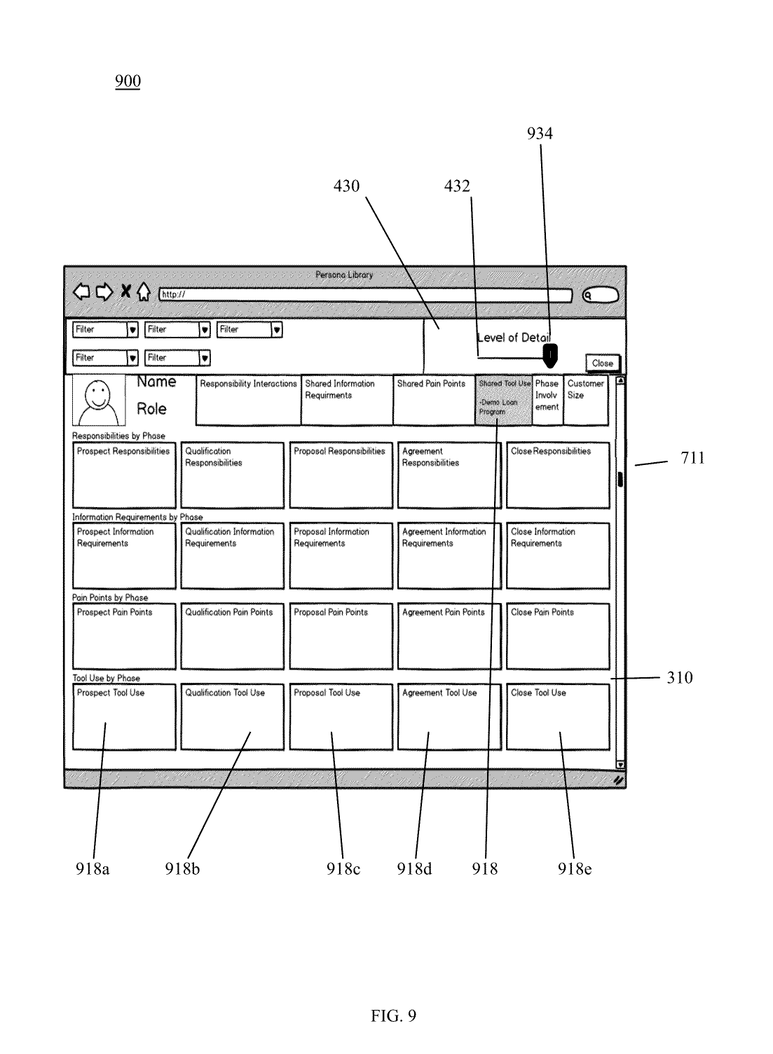

Referring to FIG. 9, and continuing to refer to prior figures for context, a graphical user interface (GUI) 900 for adjustable progressive disclosure of structured data in accordance with the continuing example is presented. In the example, the GUI 900, elements referred to as 302-316, 430, 432, 518-520, 615, 615a-615e, 711, 716, 716a-716e, 817, and 817a-817e are described elsewhere herein. FIG. 9 illustrates position indicator 934 moved to the right relative to the position of position indicator 834 of FIG. 8. As a consequence, the sixth and final level of abstraction illustrated in TABLE 2 is displayed in portion 310 of the GUI. In addition to displaying a photo 312, role 313, name 314, responsibility interactions 615, shared information requirements 716, phase involvement 319, and customer size 320 for each persona responsive to the category selected and any filters applied, portion 310 displays an alternate shared tools box 918, along with tools used by phase boxes project tools used 918a, qualification tools used 918b, proposal tools used 918c, agreement tools used 918d, and close tools used 918e in portion 310.

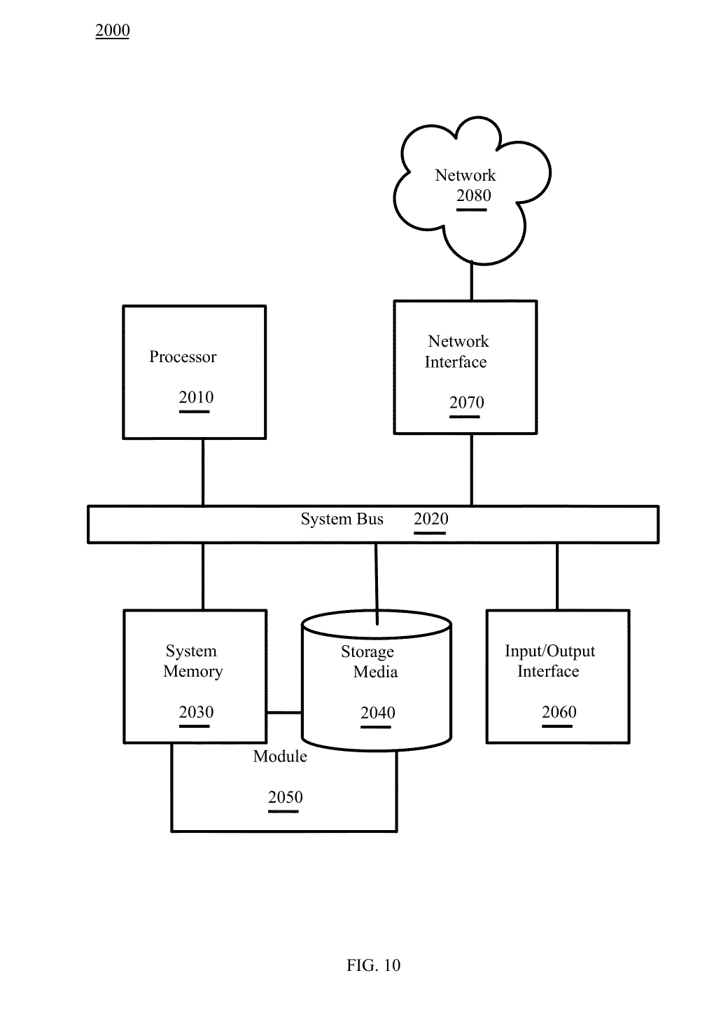

FIG. 10 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components, for example, a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories, for example, read-only memory (ROM), programmable read-only memory (PROM), erasable programmable read-only memory (EPROM), flash memory, or any other device capable of storing program instructions or data with or without applied power. The system memory 2030 may also include volatile memories, for example, random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device, for example, the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid sate drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules, for example, module 2050, data, or any other information. The storage media 2040 may be part of, or connected to, the computing machine 2000. The storage media 2040 may also be part of one or more other computing machines that are in communication with the computing machine 2000, for example, servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits, for example, microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, for example, small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media, for example, fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device, for example, a system on chip (SOC), system on package (SOP), or ASIC device.

In situations in which the technology discussed here collects personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (, for example, to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Additionally, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the technology described herein. For example, embodiments of the technology can be implemented on a single computing device (for example a user computing device), or in a cloud computing architecture.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

We claim:

1. A method, comprising:
defining, in one or more computing devices, representations of a structured data set, the representations ordered by level of abstraction;
causing, by the one or more computing devices, to be displayed in a graphical user interface (GUI), a defined representation of the structured data set at one of the levels of abstraction;
causing, by the one or more computing devices, to be displayed in the GUI, a progressive disclosure object, the progressive disclosure object comprising a one-dimensional range having ordered positions along the range corresponding to each level of abstraction of the defined representations, and the progressive disclosure object comprising a position indicator at a first position on the range associated with the level of abstraction of the displayed representation, the position indicator movable along the range via the GUI;
receiving, by the one or more computing devices, via the GUI, input changing the position of the position indicator to a second position different than the first position; and
causing, by the one or more computing devices, to be displayed in the GUI, the defined representation of the structured data set at the level of abstraction corresponding to the second position of the position indictor.

2. The method of claim 1, wherein the progressive disclosure object is a linear slider.

3. The method of claim 1, wherein the progressive disclosure object is a non-linear slider.

4. The method of claim 3, wherein the non-linear slider is a circular dial.

5. The method of claim 4, wherein position on the circular dial is measured by total distance traveled between the first position and the second position.

6. The method of claim 1, wherein the structured data set is a hierarchical tabular data set, and wherein at least one representation of the structured data set comprises data from different levels of the hierarchy of the hierarchical tabular data set.

7. The method of claim 6, wherein at least one representation of the structured data set comprises a summary of at least one level of the hierarchy of the hierarchical tabular data set.

8. A tangible, non-transitory, computer-readable media having software encoded thereon, the software when executed by a processor operable to:
define, in one or more computing devices, representations of a structured data set, the representations ordered by level of abstraction;
cause to be displayed, in a graphical user interface (GUI) of a computing device, a defined representation of the structured data set at one of the levels of abstraction;
cause to be displayed, in the GUI, a progressive disclosure object, the progressive disclosure object comprising a one-dimensional range having positions along the range corresponding to each level of abstraction of the defined representations, and the progressive disclosure object comprising a position indicator at a first position on the range associated with the level of abstraction of the displayed representation, the position indicator movable along the range via input to the GUI;
receive, via the GUI, input changing the position of the position indicator to a second position different than the first position; and
cause to be displayed, in the GUI, the defined representation of the structured data set at the level of abstraction corresponding to the second position.

9. The computer-readable media of claim 8, wherein the progressive disclosure object is a linear slider.

10. The computer-readable media of claim 8, wherein the progressive disclosure object is a non-linear slider.

11. The computer-readable media of claim 10, wherein the non-linear slider is a circular dial.

12. The computer-readable media of claim 11, wherein position on the circular dial is measured by total distance traveled between the first position and the second position.

13. The computer-readable media of claim 8, wherein the structured data set is a hierarchical tabular data set, and wherein at least one representation of the structured data set comprises data from different levels of the hierarchy of the hierarchical tabular data set.

14. The computer-readable media of claim 13, wherein at least one representation of the structured data set comprises a summary of at least one level of the hierarchy of the hierarchical tabular data set.

15. An apparatus, comprising:
a processor adapted to execute one or more processes; and
a memory configured to store a process executable by the processor, the process when executed operable to:
define, in one or more computing devices, representations of a structured data set, the representations ordered by level of abstraction;
cause to be displayed, in a graphical user interface (GUI) of a computing device, a progressive disclosure object, the progressive disclosure object comprising a one-dimensional range having ordered positions along the range corresponding to each level of abstraction of the defined representations, and the progressive disclosure object comprising a position indicator movable along the range by a user via the GUI;
cause to be displayed, in the GUI, a defined representation of the structured data set at one of the levels of abstraction;
cause to be displayed, in the GUI, the position indicator at a first position on the range associated with the level of abstraction of the displayed representation;
receive, via the GUI, input changing the position of the position indicator to a second position different than the first position; and
cause to be displayed, in the GUI, the defined representation of the structured data set at the level of abstraction corresponding to the second position.

16. The apparatus of claim 15, wherein the progressive disclosure object is a linear slider.

17. The apparatus of claim 15, wherein the progressive disclosure object is a non-linear slider.

18. The apparatus of claim 17, wherein the non-linear slider is a circular dial.

19. The apparatus of claim 18, wherein position on the circular dial is measured by total distance traveled between the first position and the second position.

20. The apparatus of claim 15 wherein the structured data set is a hierarchical tabular data set, and at least one representation of the structured data set comprises data from different levels of the hierarchy of the hierarchical tabular data set.
